(19) United States
(12) Patent Application Publication
(10) Pub. No.: US 2002/0055890 A1
(43) Pub. Date: May 9, 2002

(54) Recommendation information providing method, recommendation information transmission system, recommendation information transmission apparatus and computer memory product

(76) Inventor: Thomas Aquinas Foley, Nishinomiya-shi (JP)

Correspondence Address: BIRCH STEWART KOLASCH & BIRCH, PO BOX 747, FALLS CHURCH, VA, 22040-0747, US

(21) Appl. No.: 09/860,628

(22) Filed: May 21, 2001

(30) Foreign Application Priority Data
Sep. 14, 2000 (JP) 2000-280856

(51) Int. Cl. G06F 17/60

(52) U.S. Cl. 705/27; 705/1

(57) ABSTRACT

A recommendation information providing method is provided for providing recommendation information concerning a recommended object appropriate for a customer. A recommendation information transmission apparatus stores recommended object information concerning a plurality of recommended objects and relationships among respective recommended objects. And, in the case that a customer clicks the link concerning a recommended object or purchases a recommended object, or the like, the behavior information with respect to the behavior is stored. Then, by calculating degree of recommendation for each recommended object using these pieces of recommended object information and behavior information the recommended object which is to be recommended to the customer is determined so that the recommendation information concerning the determined recommended object is provided to the customer.

### BACKGROUND OF THE INVENTION

1. Field of the Invention

The present invention relates to a recommendation information providing method for providing recommendation information concerning a recommended object to a customer, to a recommendation information transmission system and a recommendation information transmission apparatus for carrying out the method as well as to a computer memory product which records a computer program for making a computer function as the recommendation information transmission apparatus.

2. Description of Prior Art

Accompanying the rapid spread of the Internet in recent years, the so-called electronic commerce (EC) market, wherein virtual shops are installed on the communication network so that a variety of goods are sold in the virtual shops, has been expanding. At the WWW site (hereinafter referred to as an EC site) wherein such electronic commerce is carried out, instead of providing the same contents to all of the customers who have accessed the site a service for providing different content in accordance with the tastes and preferences of each customer (hereinafter referred to as personalized service) has been implemented in order to improve customer satisfaction.

In order to implement such as personalized service, a rule based technology or a cooperative filtering technology has conventionally been adopted.

The rule based technology is a technology for predefining a variety of knowledge as rules and for providing different contents according to each customer by drawing out appropriate contents appropriate to a customer who has accessed the site based on those rules.

On the other hand, the cooperative filtering technology is a technology for storing the access history of a great number of customers as data so that an access history which is similar to the access history of the customer who has accessed the site is extracted from the above described stored data and a technology for forming and providing, based on the extracted access history, the contents appropriate to the customer who has accessed the site.

By implementing a personalized service through the usage of the above described rule based technology or cooperative filtering technology, it has become possible to recommend appropriate goods in accordance with a customer who has accessed the site and, as a result, this has enabled increased sales of the EC site.

However, in the case that of the rule based technology, it is necessary to predefine the rules as described above and, therefore, the knowledge engineers should draw out a variety of knowledge from experts who have a deep knowledge of goods so as to construct and manage an enormous number of proper rules based on the drawn out knowledge. Since such as task is necessary, there is the problem that a considerable cost is involved in order to implement a personalized service utilizing the rule based technology.

There is also the problem that this technology lacks flexibility because alteration of once constructed rules requires the same task as in the case of making new rules.

On the other hand, in the case of the cooperative filtering technology access histories of a great number of customers are necessary as data as described above and, therefore, it is a presupposition that such data are to be prepared in advance. Accordingly, in the case that an EC site is newly opened or in the case that a new product is sold, or the like, data cannot, in many cases, be sufficiently prepared and, therefore, there is the problem that the cooperative filtering technology cannot be utilized.

### BRIEF SUMMARY OF THE INVENTION

The present invention is provided considering the above described factors and the purpose thereof is to provide a recommendation information providing method which can provide appropriate recommendation information to a customer without requiring a tremendous number, or amount, of rules or data unlike in a conventional case by utilizing recommended object information concerning a plurality of recommended objects and relationships among respective recommended objects as well as behavior information concerning the behaviors of customers, a recommendation information transmission system and a recommendation information transmission apparatus for carrying out the method and a computer memory product which records a computer program for making a computer function as the recommendation information transmission apparatus.

Another purpose of the present invention is to provide a recommendation information providing method and a recommendation information transmission system which can visually represent recommended object information by expressing the recommended object information using a semantic network.

Still another purpose of the present invention is to provide a recommendation information providing method and a recommendation information transmission system which can provide more appropriate recommendation information according to the attribute of behavior information to a customer by giving degree of importance defined based on the attribute information included in the behavior information to the behavior information and by calculating the degree of recommendation based on the behavior information including this given degree of importance and recommended object information.

Yet another purpose of the present invention is to provide a recommendation information providing method and a recommendation information transmission system which can provide more appropriate recommendation information in accordance with the types of behavior information group to a customer by forming behavior information groups through the classification of behavior information into types of behaviors so that a degree of importance defined based on the types are given to these behavior information groups and by calculating the degree of recommendation based on the behavior information including this given degree of importance and the recommended object information.

Still yet another purpose of the invention is to provide a recommendation information providing method and a recommendation information transmission system which can carry out processing with high flexibility compared to a conventional rule based technology by modifying the degree of recommendation for each recommended object based on the behaviors of a customer after the recommendation information is provided to the customer.

In the case of invention, recommended object information concerning a plurality of recommended objects and the relationship of respective recommended objects is received and the behavior information concerning the behavior of customers is collected. Next, based on the received recommended object information and collected behavior information, the degree of recommendation for each recommended object is calculated and a recommended object matching the recommendation information to be provided to the customer is selected from a plurality of recommended objects based on the calculated degree of recommendation. Then the recommendation information concerning this selected recommended object is provided to the customer.

In this manner, a personalized service is realized using recommended object information concerning a plurality of recommended objects and the relationship between respective recommended objects and behavior information concerning the behavior of customers. Accordingly, it is not necessary to construct and manage the rules, unlike as in the case of a conventional rule based technology and, therefore, a personalized service can be realized at much lower cost.

In addition, since recommended object information is knowledge concerning nature of a recommended object, even in the case that there is no sales experience, or the like, concerning the recommended object it is possible to draw out such knowledge from an expert who possesses such knowledge. Therefore, it is possible to prepare recommended object information in advance, even in the case that an EC site is newly opened or in the case that a new product is sold, or the like, and a personalized service can be implemented in those cases.

Here, the “recommended object” may not only be goods sold through an EC site but may also be a concept related to goods. That is to say, for example, in the case that the goods are CDs, musicians, musical styles and the like with respect to the CDs can be a “recommended object.”

In the case of the invention, recommended object information is expressed using a semantic network. Here, the semantic network is a model of knowledge expression which expresses knowledge structurally in a graph by making concepts correspond to nodes and making relationships between the two concepts correspond to arcs, respectively. Through the expression in this way recommended object information can be visually represented and, therefore, it becomes possible to easily grasp the meaning of the contents of the recommended object information, and modification and alteration of the recommended object information can be easily carried out.

In addition, in the case that the semantic network is used, since all of the information concerning a certain recommended object can be accessed from a node corresponding to that recommended object, the efficiency of search processing can be improved.

In the case of the invention the information which indicates the behavior of a customer includes the attribute information indicating the attribute of the behavior and degree of importance defined based on the attribute information is given.

For example, with respect to the behavior of a customer such as “a customer clicked a link with respect to a CD in order to refer to the information related to the CD” there is an attribute such as reference time wherein the customer refers to the information relating to the CD. In this case, it is possible to estimate the degree of interest of the customer in that CD by the length of this reference time. Accordingly, the degree of importance is defined based on the reference time which is an attribute of behavior and by using the defined degree of importance for the calculation of the degree of recommendation for each recommended object, it becomes possible to provide appropriate recommendation information concerning the recommended object.

In the case of the invention, behavior information groups are formed by classifying and correcting information indicating the behavior of customers into types of behaviors and degree of importance based on the types are given to each of these behavior information groups.

In a EC site which sells CDs there are types such as “clicked a link with respect to a CD,” “purchased a CD” and the like among the behaviors of customers. In this case, the behavior with respect to the former type can become a positive reason for recommending the CD to the customer but the behavior with respect to the latter type cannot be such a positive reason because a customer rarely purchases the same CD in a plurality of numbers. Accordingly, it is necessary to pay attention to the types of behaviors of customers when the recommended objects are selected. Therefore, as described above, degree of importance is defined based on the types of behavior and by using the defined degree of importance for the calculation of degree of recommendation for each recommended object, it becomes possible to provide appropriate recommendation information with respect to a recommended object to a customer.

In the case of the invention, degree of recommendation for each recommended object is modified based on the behaviors of a customer after recommendation information is provided to the customer.

For example, in the case that information with respect to a jazz CD is provided to a customer as recommendation information based on a hypothesis that “the customer likes jazz” and the customer purchased that CD, the above described hypothesis is confirmed and, therefore, a modification such as the enhancement of the degree of recommendation for jazz and jazz CDs is carried out. Thereby, the response of a customer in the case that recommendation information provided to a customer can be utilized when recommendation information is provided the next time.

Here, in the above described example, in the case that customer didn't purchase the jazz CD with respect to the provided recommendation information for a certain period of time, the above described hypothesis can be judged as not being confirmed and, thereby, it is possible to carry out a modification, such as the lowering of the degree of recommendation for jazz and jazz CDs. In this way, no response from the customer to the recommendation information can be processed as a behavior of the customer.

In addition, the recommendation information is displayed together with a character image which is animated. Accordingly, the customer can receive the providing of recommendation information with more enjoyment.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing a configuration of a recommendation information transmission system according to the present invention;

FIG. 2 is a schematic diagram showing an example of recommended object information;

FIG. 3 is a schematic view showing an example of behavior information;

FIG. 4 is a flow chart showing a process procedure of a recommendation information transmission apparatus according to the present invention in the case that the evidence value is updated; and

FIG. 5 is an exemplary view for describing degree of recommendation.

### DEATAILED DESPRICTION OF THE INVENTION

The recommendation information transmission system in the present mode is a system in the case which is applied to WWW site wherein CDs are sold. Accordingly, in the present mode, CDs as well as musicians, musical styles and the like with respect to the CDs are the recommended objects.

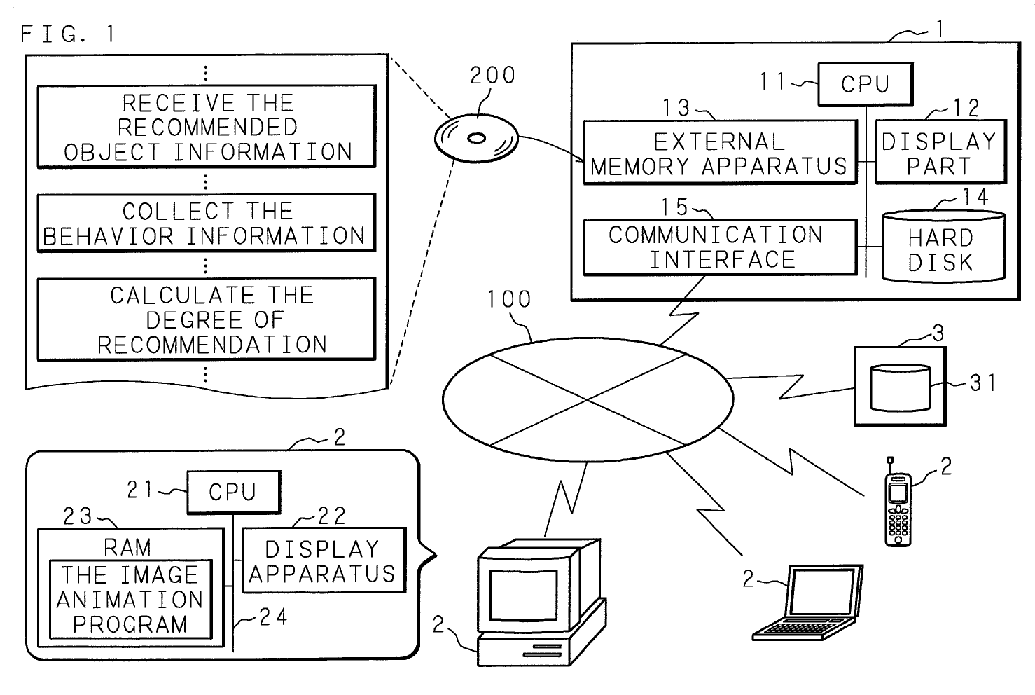

FIG. 1 is a block diagram showing a configuration of a recommendation information transmission system according to the present invention. In FIG. 1, a recommendation information transmission apparatus which transmits recommendation information concerning a particular recommendation object is denoted as 1. The recommendation information transmission apparatus 1 is connected to the communication network 100 such as Internet and WWW site which sells CDs is run via the communication network 100.

In addition, terminal apparatuses such as personal computers, PDA (personal digital assistants) and cellular phones are denoted as 2, 2 . . . and respective terminal apparatuses 2, 2 . . . are connected to the same communication network 100. Those terminal apparatuses 2, 2 . . . have a WWW browsing function and thereby customers can browse a variety of information received from WWW site run by the recommendation information transmission apparatus 1 possible.

A display apparatus 22, such as a liquid crystal display, and a RAM 23 are connected to a CPU (Central Processing Unit) 21 of the terminal apparatus 2 via a bus 24. The CPU 21 displays the recommendation information which is transmitted from the recommendation information transmission apparatus 1 on the display apparatus 22. In addition, an image animation program is stored in the recommendation information transmission apparatus 1. The image animation program is transmitted to the terminal apparatus 2 together with the recommendation information. The CPU 21 loads the transmitted image animation program into the RAM 23 so as to run this program. Thereby, a character image which is animated is displayed together with the recommendation information.

As shown in FIG. 1, the recommendation information transmission apparatus 1 has a CPU 11 and this CPU 11 is connected to each part of the following hardware so as to control it and performs a variety of computer programs which are stored in a hard disk 14.

A RAM 12 is constructed of, for example, a SRAM and stores temporal data generated at the time of a computer program implementation.

An external memory apparatus 13 is constructed of a CD-ROM drive, a flexible disk drive or the like which reads out the above described computer programs from a portable type computer memory product 200 such as a CD-ROM, a flexible disk or the like wherein computer programs required for the operation of the recommendation information transmission apparatus 1 of the present invention are stored.

The hard disk 14 is constructed of, for example, a DRAM and stores the above described computer programs and a variety of data which are read out by the external memory apparatus 13. Those stored data include recommended object information concerning a plurality of recommended objects and relationships between respective recommended objects as described in the following.

The communication interface 15 is an interface for the connection with the communication network 100 and is, for example, constructed of a modem in the case of the connection with the communication network 100 via an analog line and is constructed of a DSU (digital service unit) in the case of the connection with the communication network 100 via a base band transmission type digital line.

The computer programs of the recommendation information transmission apparatus 1 according to the present invention, in addition to read out from the portable type computer memory product 200, connects to an external server computer 3 via the communication network 100 so that it is possible to download the above described computer programs to the recommendation information transmission apparatus 1 from a recording medium 31 which is built in the external server computer 3 and which records the above described computer program. This downloaded program is stored hard disk 14. CPU11 loads the downloaded program into the RAM12. Therefore recommendation information transmission apparatus 1 performs operations as described in the following.

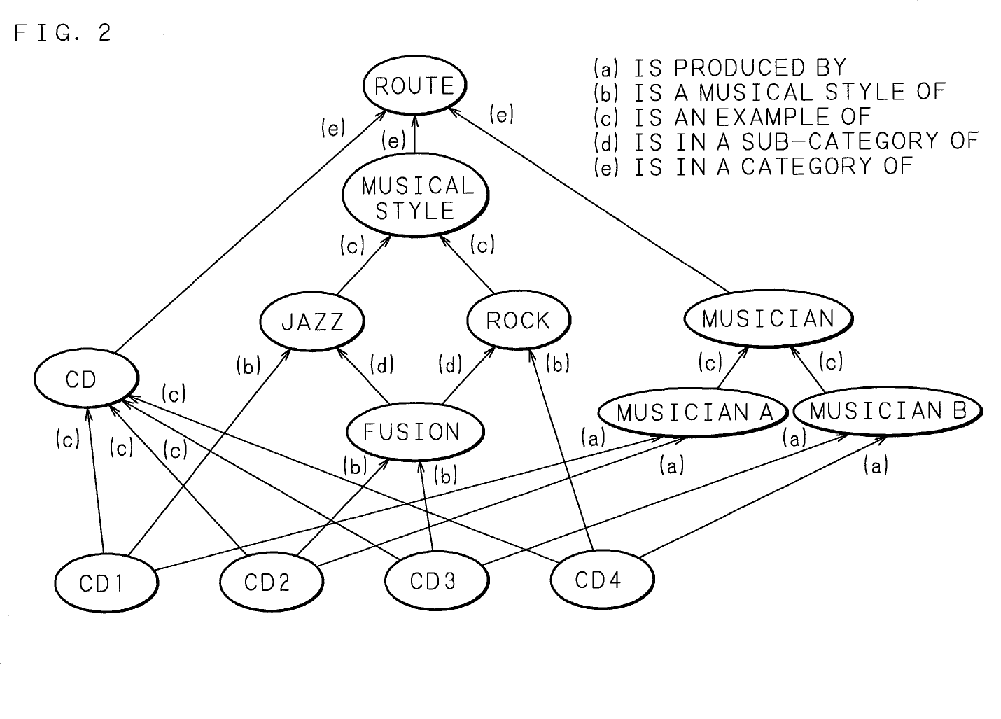

Next, the above described recommended object information is described by using a schematic view of the recommended object information as shown in FIG. 2. As shown in FIG. 2, the recommended object information is expressed by using a semantic network. In FIG. 2, arcs which make links between respective nodes are indicated to mean any of the relationships (a), (b), (c), (d) or (e). For example, it is indicated that the relationship of (a) “produced by” between the “CD 1” and the “musician A.” This relationship expresses the knowledge of “the CD 1 is produced by the musician A.” In the same way, it is indicated that there is a relationship of (b) “is a musical style of” between the “CD 1” and “jazz” and thereby the knowledge “the CD 1 is a musical style of jazz” is expressed.

As shown in FIG. 2, each arc has a directional property and the direction thereof is indicated by an arrow. A graph formed only by arcs which have such a directional property is referred to as a DAG (directed acyclic graph). In a DAG it is secured that every node has no path to return to the same node.

The above described recommended object information is formed manually by knowledge engineers after drawing out a deep knowledge of goods from experts (for example, sales clerks at CD shops) who possess such a knowledge so as to be inputted into the recommendation information transmission apparatus 1.

Here, though, in the present mode, the recommendation information transmission apparatus 1 runs WWW site which sells CDs, goods other than CDs such as books, foods, clothes or the like may, of course, be included. It is also possible to use in the case of offering a variety of services instead of selling goods. For example, it is possible to provide appropriate advice to an operator in a telephone center or at a help desk, to provide appropriate study guidance to each student, or the like.

Next, the operation of the recommendation information transmission system according to the present invention is described.

A customer accesses WWW site run by the recommendation information transmission apparatus 1 by using the terminal apparatuses 2, 2 . . . and displays information concerning a CD by clicking the link with respect to the CD in order to refer to the information concerning the CD which is sold by the WWW site or purchases the CD.

Events such as the above described clicking or the purchase of the CD indicates the behavior of the customer. The recommendation information transmission apparatus 1 collects behavior information indicating the behavior of a customer by receiving such events from the customer so as to be stored in the hard disk 14.

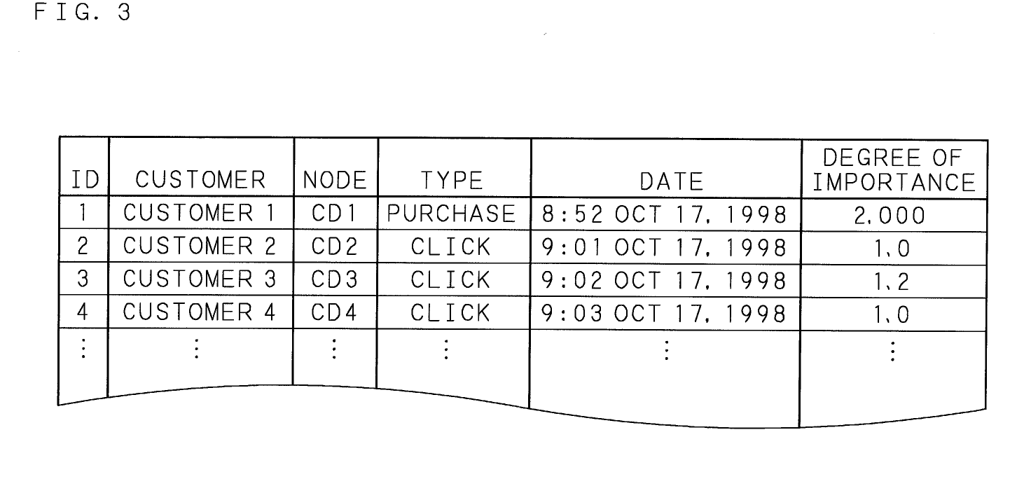

FIG. 3 is a schematic view showing an example of the behavior information. As shown in FIG. 3, the behavior information provides respective fields of an ID field, a customer field, a node field, a type field, a date field and degree of importance field.

Here, the ID field stores an identifier (hereinafter referred to as an event ID) for identifying the event showing the behavior of a customer, the customer field stores an identifier for identifying a customer who is the subject of the event and the node field stores a node indicating the recommended object concerning the event, respectively.

In addition, the type field stores the type of the event, the date field stores the date when the event occurred and the degree of importance field stores the degree of importance defined for the event, respectively.

In an example as shown in FIG. 3, the behavior information in the case where an event of, for example, “a customer 1 purchased a CD 1 at 8:52 on October 17, 1998” is received is shown and it is indicated that the event ID of this event is “1” and degree of importance “2,000” is given to this event. In the same way, the behavior information in the case that the event of “a customer 2 clicked the link with respect to a CD 2 at 9:01 on October 17, 1998” is received is shown and it is indicated that the event ID of this event is “2” and the degree of importance “1.0” is given to this event.

Here, the value of degree of importance stored in the degree of importance field is a value indicating the price of the purchased CD in the case that “purchase” is stored in the type field and is a value indicating time when a link with respect to the CD is clicked and the page with respect to the link is referred to by the customer in the case that “click” is stored in the type field.

The recommendation information transmission apparatus 1 carries out classification processing of the behavior information according to the values stored in the type field. That is to say, for example, the classification into the behavior information of which the value in the type field is “purchase” and the behavior information of which the value in the type field is “click” is carried out. A set of the behavior information classified here is, hereinafter, referred to as an event stream.

The recommendation information transmission apparatus 1 which stores the behavior information as shown in FIG. 3 carries out the calculation of degree of recommendation for each recommended object by performing the processing as shown in the following. In the case that this degree of recommendation is calculated, the recommendation information transmission apparatus 1 performs calculation processing of the evidence value in each node forming the recommended object information. Here, the evidence means an event (for example, “customer clicked a link concerning a jazz CD” or “customer purchased a jazz CD”) which can be a proof for a certain hypothesis (for example, “customer likes jazz”, or the like) and the evidence value means the value in the case such evidence is converted to a numeral. In the following description evidence values are represented as E_{n, s}. Here, an identifier for identifying the node is denoted as n and an identifier for identifying the event stream is denoted as s, respectively.

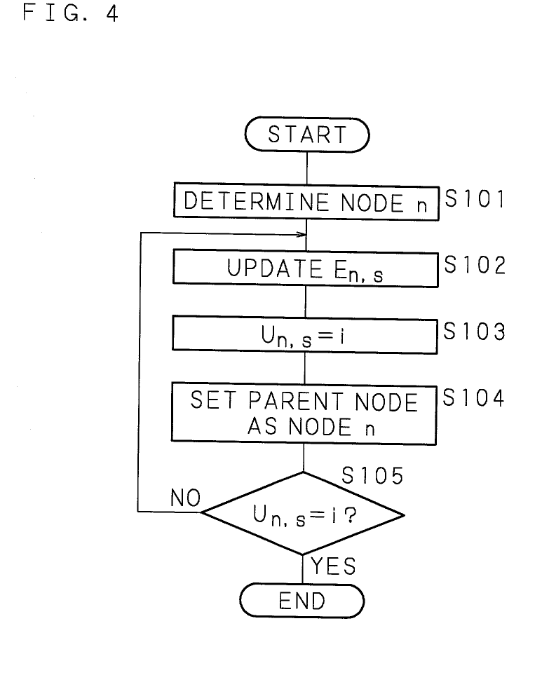

FIG. 4 is a flow chart showing a process procedure of the recommendation information transmission apparatus 1 according to the present invention in the case that the evidence value is updated. Here, 0 is set as the evidence value in each node forming the recommended object information as a default value.

In the case that an event is received from a customer, the recommendation information transmission apparatus 1 decides the node n concerning the received event (S101). Here, the node the concerning the event is the node which becomes a direct object of that event and is a value which is stored in the node field in the behavior information. For example, in the case that the event is “customer 1 purchased a CD 1 at 8:52 on October 17, 1998,” the node corresponding to the “CD 1” becomes a node concerning the event.

Next, E_{n, s} is updated (S102) through the calculation of E_{n, s} in node n using the equation described below. Then, i is set as a value of the variable U_{n, s} which indicates that the calculation of E_{n, s} is already carried out with respect to the i^{th} event in the event stream s for node n (S103). Next, a parent node of the node which is the object of the present processing is set at node n (S104), and it is determined whether or not the value of U_{n, s} in that node n is i (S105). Here, in the case that value. of U_{n, s} is determined not to be i (NO in S105), the process returns to step S102 to repeat the process. On the other hand, in the case that the value of U_{n, s} of the node n is determined to be i (YES in S105) it is determined that the updating process of E_{n, s} for the i^{th} event in the event stream s for that node n has already been carried out and the process is completed.

Through the above described process the evidence values in all of the nodes which can be reached from the nodes which have been determined to be nodes concerning the events in step S101 are sequentially operated.

Next, several equations used to calculate the evidence value are described. The first equation is E_{n, s}=E′_{n, s}+e_{s, 1} (equation (1)). Here, E′_{n, s} represents the evidence value in the node n before the evidence value is updated and e_{s, 1} represents the degree of importance (value stored in the degree of importance field) of the i^{th} event in the event stream s.

The second equation is E_{n, s}=f(E′_{n, s}, e_{s, 1}, tₙ) (equation (2)). Here, tₙ represents time elapsed since the point in time when the evidence value was updated the previous time in node n or the number of processing cycles which have been carried out after have been similarly updated. Here, this number of processing cycles can be calculated by i−U_{n, s}.

Though it is possible to calculate the evidence value reflecting the degree of importance of the event from the above described equations (1) and (2), the difference between a new event and an old event in time cannot be reflected. In many cases customers tastes and preferences change over time and in such cases it is necessary to handle differently the event accepted recently from the event accepted previously. To distinguish in this way the equations (3) and (4) as described below are adopted.

The third equation is E_{n, s}=(1-α)e_{s, 1}+αₛE′_{n, s} (equation (3)). Here, αₛ is a parameter for controlling the handling of the difference of the degree of importance between the newest event and the previous event before that event in the event stream s. And the fourth equation is E_{n, s}=(1−αₓ)e_{x, 1}+power(α_{s,} i−U_{n, s}) E′_{n, s} (equation (4)). Here power represents a function for calculating the power of a number.

In the case that the recommendation information transmission apparatus 1 receives an event from the customer, the equation (3) is used when the evidence values in all of the nodes forming the recommended object information are updated and, on the other hand, the equation (4) is used when the evidence values in several nodes are not updated.

The calculation result of the evidence value in the case that the recommendation information transmission apparatus 1 has received two events wherein the event IDs in FIG. 3 are “3” and “4” is shown in Table 1. Here, the evidence value is calculated by using the above described equation (4) and the value of the parameter αₛ is set at 0.5.

TABLE 1

| | Evidence value after | Evidence value after |
|---|---|---|
| | reception of event | reception of event |
| Node | wherein event ID = 3 | wherein event ID = 4 |
| CD 1 | 0.00 | 0.00 |
| CD 2 | 0.00 | 0.00 |
| CD 3 | 0.60 | 0.30 |
| CD 4 | 0.00 | 0.50 |
| CD 5 | 0.60 | 0.80 |
| Musician A | 0.00 | 0.00 |
| Musician B | 0.60 | 0.80 |
| Musician | 0.60 | 0.80 |
| Jazz | 0.60 | 0.30 |
| Fusion | 0.60 | 0.30 |
| Rock | 0.60 | 0.80 |
| Musical style | 0.60 | 0.80 |
| Root | 0.60 | 0.80 |

As described above, the degree of recommendation of recommenced object can be determined through the method described below based on the evidence value updated in each node. As for the method of deciding the degree of recommendation, there are (1) a method of making the evidence value itself be the degree of recommendation, (2) a method of making the hypothesis be the degree of recommendation, (3) a method of using a plurality of event streams and the like. In the following, these methods are, respectively, described.

(1) Method of Making the Evidence Value Itself be the Degree of Recommendation

By repeatedly carrying out the calculation processing of the above described evidence value, the evidence value in each node is updated and rearranging respective nodes in the order of from larger value to smaller value based on the updated evidence values and, after that, in the case that a filtering criterion (for example, top ten musicians, or the like, for the best 100 CDs or for a certain customer) is set, a node which satisfies that criterion is selected, on the other hand, in the case that the filtering criterion is not set, the node concerning the highest degree of recommendation is selected. Then, the recommended object corresponding to this selected node is made to be the recommended object concerning the recommendation information which is to be provided to the customer. That is to say, in this case, the evidence value itself becomes the degree of recommendation.

Here, in this processing, by using a search method such as a branch and bound method, or the like, it is possible to carry out the search processing more effectively for each node.

(2) Method of Making the Hypothesis be the Degree of Recommendation

The recommendation information transmission apparatus 1 judges whether the source of the evidence value calculated as described above is a child node or a parent node in order to find a node corresponding to the recommended object which is to be recommended from among a plurality of nodes forming the recommended object information. Here, the source of the evidence value means the node which has exercised the greatest influence at the time of calculation of that evidence value.

In order to carry out the above described judgment a hypothesis H_{n0, s, N}, which indicates that the node n0 is the source of the evidence value E_{n0, s} and its parent node N is not its source, is calculated according to the procedure described below. This hypothesis H_{n0, s, N} takes the value from 0 to 1.

In order to calculate this H_{n0, s, N}, comparative processing of E_{n, s}/O_{n, s} (hereinafter referred as an evidence ratio) in the two different nodes are carried out. Here, O_{n, s} represents the total number of opportunities where events of the type concerning the stream s in the node n can occur and, for example, in the case that the type is “purchase” the total number, or the like, of the numbers that the screen information used for purchasing the recommended object which corresponds to the node n is provided to the customer becomes the above described total number of the opportunities.

In the case that comparative processing of the evidence ratio in two different nodes is carried out, the recommendation information transmission apparatus 1 calculates a probability variable z following the standard normal distribution by using a well known equation so as to gain the value from 0 to 1 by referring to the table of cumulative normal distribution based on the value of this calculated probability variable z.

Following the above described procedure, the recommendation information transmission apparatus 1 judges whether or not the evidence ratio in the node n0 is larger than the evidence ratio in the node (hereinafter referred to as a brother node) which has, as a parent node, the same parent node N as the node n0 and, in the case that it is larger H_{n0, s, N} is formed, that is to say, it can be judged that the node n0 is the source of the evidence value E_{n0, s}. And, in the case that the values of the two are approximately the same, the parent node N of the node n0 (or a node which is superior to that) is judged to be a source of the evidence value E_{n0, s}.

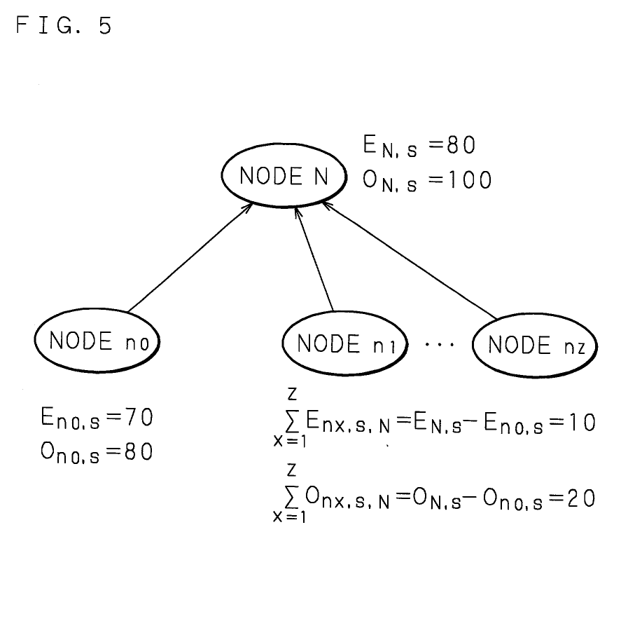

For example, as shown in FIG. 5, in the case that the evidence ratio in node n0 is 70/80 and the evidence ratio in its parent node N is 80/100, the evidence ratios of the nodes n1 to nz which are the brother nodes of the node n0 become 10/20. In this case, the above described value of the probability variable z is calculated as 3.75 using know equations and by referring to a table of the cumulative normal distribution based on this value H_{n0, s, N}=99.9912% is gained. This result confirms that the node n0 is the source of the evidence value.

In addition, in the case that the above described statistical method is used it is necessary for the numbers of pieces of data to sufficiently exist and, in the case that they are not sufficient, it is not appropriate to use such a method. Therefore, in the case that the number of pieces of data is not sufficient in this way the value of 2 5 the probability variable z is calculated through the usage of the equation (5) described below by assuming that an event is accepted from a customer in accordance with the Poisson distribution.

$$Zn0 \cdot s \cdot N = \frac{En0 \cdot s - {\sum }_{x = 1}^{Z} Enx \cdot s \cdot N}{sqrt ( En0 \cdot s + {\sum }_{x = 1}^{Z} Enx \cdot s \cdot N )} \qquad \text{Equation (5)}$$

Here, sqrt is a function to calculate square roots. As described above, the evidence values of the brother nodes n1 to nz can be calculated by subtracting the evidence value of the node n0 from the evidence value of the parent node N and, therefore, the equation (5) can be transformed as follows:

z_{n0, s, N}=(E_{n0, s}−(E_{N, s}−E_{n0, s}))/sqrt(E_{n0, s}+(E_{N, s}−E_{n0, s})) (equation (6))

The recommendation information transmission apparatus 1 calculates Z_{n0, s, N} and H_{n0, s, N} for every pair of a child node n0 and a parent node N in the recommended object information. The calculation examples of the evidence values as shown in Table 1 are used the calculate Z_{n0, s, N} and H_{n0, s, N}, of which the results are shown in Table 2.

TABLE 2

| _{N}0 | E_{n0, s} | N | E_{N, s} | z_{n0, s. N} | H_{n0, s, N} |
|---|---|---|---|---|---|
| CD 1 | 0.0 | Musician A | 0.0 | — | — |
| CD 2 | 0.0 | Musician A | 0.0 | — | — |
| CD 3 | 0.3 | Musician B | 0.8 | −0.22 | 41% |
| CD 4 | 0.5 | Musician B | 0.8 | 0.22 | 59% |
| CD 1 | 0.0 | Jazz | 0.3 | −0.55 | 29% |
| CD 2 | 0.0 | Fusion | 0.3 | −0.55 | 29% |
| CD 3 | 0.3 | Fusion | 0.3 | 0.55 | 71% |
| CD 4 | 0.5 | Rock | 0.8 | 0.22 | 59% |
| Musician A | 0.0 | Musician | 0.8 | −0.89 | 19% |
| Musician B | 0.8 | Musician | 0.8 | 0.89 | 81% |
| Jazz | 0.3 | Musical | 0.8 | −0.22 | 41% |
| | | style | | | |
| Fusion | 0.3 | Jazz | 0.3 | 0.55 | 71% |
| Rock | 0.8 | Musical | 0.8 | 0.89 | 81% |
| | | style | | | |
| Fusion | 0.3 | Rock | 0.8 | −0.22 | 41% |
| CD 1 | 0.0 | CD s | 0.8 | −0.89 | 19% |
| CD 2 | 0.0 | CD s | 0.8 | −0.89 | 19% |
| CD 3 | 0.3 | CD s | 0.8 | −0.22 | 41% |
| CD 4 | 0.5 | CD s | 0.8 | 0.22 | 59% |
| CD s | 0.8 | Root | 0.8 | 0.89 | 81% |
| Musical | 0.8 | Root | 0.8 | 0.89 | 81% |
| style | | | | | |
| Musician | 0.0 | Root | 0.8 | 0.89 | 81% |

In addition, since in some cases each node has a plurality of parent nodes, lines, where the same nodes are the node n0 in Table 2, exist in a plurality of number. Therefore, the recommendation information transmission apparatus 1 calculates a hypothesis H_{n, s} of which the parent node N is not specified following the procedure described below.

First, H_{n0, s} is assumed to be 1.0 in the case that the root node is the node n0. Then, H_{n0, s, N} in the case that child nodes of the root node are the nodes n0 is multiplied by the above described 1.0 to calculate H_{n0, s} in those child nodes. This process is repeated in the following and, thereby, Hₙ₀, in each node is calculated.

In addition, in the case that a certain child node n0 has a plurality of parent nodes N, N . . . . each H_{n0, s, N} is used for each parent node N, N . . . to calculate H_{n0, s}, which are added to each other and, thereby, H_{n0, s} in the child node n0 is calculated. Based on H_{n0, s} gained in this manner, respective nodes are rearranged in the order from larger to smaller and, after that, in the case that a filtering standard is set as described above, a node which satisfies the standard is selected and, on the other hand, in the case that the filtering standard is not set, the node concerning the highest degree of recommendation is selected so that the recommended object corresponding to the selected node is made to be a recommended object concerning the recommendation information which is to be provided to the customer.

By using the calculation examples in Table 2, H_{n0, s, N} in each node is calculated, of which the result is shown in Table 3.

TABLE 3

| _{N}0 | H_{n0 s} |
|---|---|
| Root | 1.000 |
| Musician | 0.814 |
| Musician A | 0.151 |
| Musician B | 0.663 |
| Musical style | 0.814 |
| Jazz | 0.335 |
| Rock | 0.663 |
| Fusion | 0.510 |
| CD s | 0.814 |
| CD 1 | — |
| CD 2 | 0.344 |
| CD 3 | 0.969 |
| CD 4 | 1.260 |

(3) Method of Using a Plurality of Event Streams

In the methods of the above described (1) and (2), degree of recommendation is calculated for each event stream. The third method is a method of calculating degree of recommendation by using a plurality of event streams.

In this method, Hn=Θₛ₁H_{n, s1}+Θₛ₂H_{n, s2}+ . . . +Θₛ₁H_{n, s1} (equation (7)) is used to calculate a hypothesis Hₙ which is degree of recommendation in the node n. Here, ΘHₛ₁ is a weighting coefficient which is used when a plurality of event streams si (i is a natural number) are combined. For the value of this Θₛ₁, a variety of values due to the nature of the recommended object are utilized. For example, in the case that the recommended object is a CD, it is rare for a customer to purchase the same CD after purchasing a certain CD. On the other hand, for example, in the case that the recommended object is a lure for fishing, it can be considered the probability is high for a customer to purchase the same lure after purchasing a certain lure. Accordingly, in the case that a type concerning, for example, the event stream sl is “purchase” the value of Θₛ₁ for H_{n, s1} in the node n corresponding to a CD is a lower value than the value of Θₛ₁ for H_{n, s1} in the node corresponding to a lure. Here, the value of Θs1 may be a different value in accordance with each node or each customer or may be the same value. In addition, H_{n, si} is calculated in the same way as in the case that the above described H_{n0, s} is calculated.

After rearranging respective nodes in the order of from larger to smaller based on the hypothesis Hₙ gained in such a manner, in the case that a filtering standard is set as described above a node which satisfies the standard is selected and in the case that a filtering standard is not set a node concerning the highest degree of recommendation is selected so that the recommended object corresponding to the selected node is made to be a recommended object concerning the recommendation information which is to be provided to the customer.

The recommendation information transmission apparatus 1 specifies the recommended object by using the degree of recommendation calculated based on either method of the above described three methods whenever an event is received from a customer and transmits the recommendation information concerning the specified recommended object to a terminal apparatus 2, 2 . . . operated by a customer.

By repeating such a process the recommendation information transmission apparatus 1 starts to transmit recommendation information concerning a recommended object which is more appropriate to a customer. This corresponds to the learning of the recommendation information transmission apparatus 1.

In addition, the recommendation information transmission apparatus 1 can learn different contents from those described above. Therefore, in the case that a response is given for recommendation information after the recommendation information is provided to a customer, that is to say, for example in the case that the recommended object concerning the recommendation information is purchased by the customer, the recommendation information transmission apparatus 1 makes the type of event which indicates that purchase be “response” so as to be utilized for the calculation of degree of recommendation. In this case, the degree of importance of this event is set at a higher value than the degree of importance of an event where the type is “purchase” and, thereby, degree of recommendation which gives importance to the response of a customer can be calculated.

In addition, even in the case that there is no response from a customer for a certain period of time it is judged in the same manner that an event of which the type is “response” is received and the degree of importance of this event is set at a lower value than the degree of importance of an event which indicates the response in the case that there is an actual response as described above. On the contrary, it is judged that an event of which the type is “non-response” is received and the value of the Θ coefficient concerning an event stream of which the type is a “non-response” is set lower than the value of the Θ coefficient concerning other event streams. Thereby, degree of recommendation according to the case where there is no response from a customer can be calculated.

Here, it is possible to carry out such learning by using, for example, annealing, which is a well known technology, hill climbing, genetic algorithm or a neural network.

As this invention may be embodied in several forms without departing from the spirit of essential characteristics thereof, the present embodiment is therefore illustrative and not restrictive, since the scope of the invention is defined by the appended claims rather than by the description preceding them, and all change that fall within metes and bounds of the claims, or equivalence of such metes and bounds thereof are therefore intended to be embraced by the claims.

1. A recommendation information providing method for providing recommendation information, concerning a particular recommended object selected from among a plurality of recommended objects, to a customer comprising the steps of:
receiving recommended object information, concerning the plurality of recommended objects and relationships among respective recommended objects;
collecting behavior information concerning the behaviors of the customer;
calculating a degree of recommendation for each recommended object based on the received recommended object information and the collected behavior information;
selecting a recommended object that matches the recommendation information from among the plurality of recommended objects, based on the calculated degree of recommendation; and
providing recommendation information concerning the selected recommended object to the customer.

2. A recommendation information providing method according to claim 1,
wherein the recommended object information is expressed by using a semantic network.

3. A recommendation information providing method according to claim 1,
wherein the behavior information includes attribute information indicating an attribute of a behavior and a degree of importance defined based on the attribute information.

4. A recommendation information providing method according to claim 1, further comprising the step of:
forming behavior information groups by classifying the behavior information into types of behaviors,
wherein the behavior information groups include degrees of importance defined based on the types.

5. A recommendation information providing method according to claim 1, further comprising the step of
modifying the degree of recommendation for each recommended object based on the behaviors of a customer after recommendation information concerning the selected recommended object is provided to the customer.

6. A recommendation information providing method for providing, in the case of the selling of goods via a communication network, recommendation information concerning the goods with respect to sales to a customer, comprising the steps of
receiving goods information including information concerning a plurality of goods and relationships among respective goods;
collecting behavior information concerning the behaviors of the customer including information concerning an inquiry about the goods and a purchase of goods via the communication network;
calculating a degree of recommendation for each of the goods based on the received goods information and the collected behavior information;
selecting the goods with respect to the sales from among a plurality of goods based on the calculated degree of recommendation; and
providing recommendation information concerning the selected goods to the customer via the communication network.

7. A recommendation information transmission system comprising:
a terminal apparatus;
a recommendation information transmission apparatus which is connected to the terminal apparatus and which transmits recommendation information concerning a particular recommended object selected from among a plurality of recommended object to the terminal apparatus;
the terminal apparatus including:
a processor capable of performing the following operation;
accessing the recommendation information transmission apparatus and
the recommendation information transmission apparatus including:
a processor capable of performing the following operations;
receiving recommended object information concerning the plurality of recommended objects and relationships among respective recommended objects;
storing access information concerning an access, in the case that there is the access by means of the terminal apparatus;
calculating a degree of recommendation for each recommended object based on the received recommended object information and the stored access information;
selecting a recommended object that matches the recommendation information from among the plurality of recommended objects based on the calculated degree of recommendation; and
transmitting the recommendation information concerning the selected recommended object to the terminal apparatus.

8. A recommendation information transmission system according to claim 7,
wherein the recommended object information is expressed by using a semantic network.

9. A recommendation information transmission system according to claim 7,
wherein the access information includes attribute information that indicates an attribute of a behavior and a degree of importance defined based on the attribute information.

10. A recommendation information transmission system according to claim 7,
wherein the processor of the recommendation information transmission apparatus further performs the following operation;
forming access information groups by classifying the access information into types of access, wherein the access information groups include degrees of importance defined based on the types.

11. A recommendation information transmission system according to claim 7,
wherein the processor of the recommendation information transmission apparatus further performs the following operation;
modifying the degree of recommendation for each recommended object based on the access information concerning the access by the terminal apparatus after the recommendation information is transmitted to the terminal apparatus.

12. A recommendation information transmission system according to claim 7,
wherein the processor of the recommendation information transmission apparatus further performs the following operations;
transmitting an image animation program, which is prepared in advance, to the terminal apparatus,
the terminal apparatus further including:
a display apparatus connected to the processor;
wherein the processor of the terminal apparatus further performs the following operations;
displaying the transmitted recommendation information, and
running the transmitted image animation program so as to display an animated image together with the recommendation information.

13. A recommendation information transmission apparatus which is connected to a terminal apparatus and which transmits recommendation information concerning a particular recommended object selected from among a plurality of recommended objects to the terminal apparatus comprising:
a processor capable of performing the following operations;
receiving recommended object information concerning the plurality of recommended objects and relationships among respective recommended objects;
storing access information concerning an access in the case that there is the access by means of the terminal apparatus;
calculating a degree of recommendation for each recommended object based on the received recommended object information and the stored access information;
selecting a recommended object that matches the recommendation information from among the plurality of recommended objects based on the calculated degree of recommendation; and
transmitting the recommendation information concerning the selected recommended object to the terminal apparatus.

14. A recommendation information transmission system comprising:
a terminal apparatus;
a recommendation information transmission apparatus which is connected to the terminal apparatus and which transmits recommendation information concerning a particular recommended object selected from among a plurality of recommended objects to the terminal apparatus;
the terminal apparatus including:
means for accessing the recommendation information transmission apparatus and
the recommendation information transmission apparatus including:
means for receiving recommended object information concerning the plurality of recommended objects and relationships among respective recommended objects;
means for storing access information concerning an access in the case that there is the access by means of the terminal apparatus;
means for calculating a degree of recommendation for each recommended object based on the received recommended object information and the stored access information;
means for selecting a recommended object that matches the recommendation information from among the plurality of recommended objects based on the calculated degree of recommendation; and
means for transmitting the recommendation information concerning the selected recommended object to the terminal apparatus.

15. A recommendation information transmission apparatus which is connected to a terminal apparatus and which transmits recommendation information concerning a particular recommended object selected from among a plurality of recommended objects to the terminal apparatus comprising:
means for receiving recommended object information concerning the plurality of recommended objects and relationships among respective recommended objects;
means for storing access information concerning an access in the case that there is the access by means of the terminal apparatus;
means for calculating a degree of recommendation for each recommended object based on the received recommended object information and the stored access information;
means for selecting a recommended object that matches the recommendation information from among the plurality of recommended objects based on the calculated degree of recommendation; and
means for transmitting the recommendation information concerning the selected recommended object to the terminal apparatus.

16. A computer memory product which records a computer program for causing a computer connected to a terminal apparatus to transmit recommendation information concerning a particular recommended object selected from among a plurality of recommended objects to the terminal apparatus, the computer program comprising the steps of:
receiving recommended object information concerning the plurality of recommended objects and relationships among respective recommended objects;
storing access information concerning an access in the case that there is the access by means of the terminal apparatus;
calculating a degree of recommendation for each recommended object based on the received recommended object information and the stored access information;
selecting a recommended object that matches the recommendation information from among the plurality of recommended objects based on the calculated degree of recommendation; and
transmitting recommendation information concerning the selected recommended object to the terminal apparatus.
